(19) United States
(12) Patent Application Publication
(10) Pub. No.: US 2025/0182633 A1
(43) Pub. Date: Jun. 5, 2025

(54) METHOD AND SYSTEM FOR UTILIZING TRAFFIC INFORMATION IN UNMANNED AERIAL VEHICLE COMMUNICATION SYSTEM

(71) Applicant: ELECTRONICS AND TELECOMMUNICATIONS RESEARCH INSTITUTE, Daejeon (KR)

(72) Inventors: Kwangmyeong YANG, Seoul (KR); Kyuyeon LEE, Seoul (KR); Hyungje LEE, Seoul (KR); Jieun YU, Seoul (KR); Chungyong LEE, Seoul (KR); Dukhyun YOU, Daejeon (KR); Hoondong NOH, Daejeon (KR)

(73) Assignee: ELECTRONICS AND TELECOMMUNICATIONS RESEARCH INSTITUTE, Daejeon (KR)

(21) Appl. No.: 18/964,315

(22) Filed: Nov. 29, 2024

(30) Foreign Application Priority Data
Dec. 1, 2023 (KR) 10-2023-0172824
Apr. 8, 2024 (KR) 10-2024-0047612
Nov. 20, 2024 (KR) 10-2024-0166400

(51) Int. Cl. G08G 5/57

(52) U.S. Cl. CPC G08G 5/57

(57) ABSTRACT

An information acquisition and communication method for an unmanned aerial vehicle (UAV) may comprise: acquiring, by at least one first device, operational information or traffic information of the at least one unmanned aerial vehicle; providing, by the at least one first device, the operational information or the traffic information of the at least one unmanned aerial vehicle to the at least one unmanned aerial vehicle or to a base station affecting the communication operation of the at least one unmanned aerial vehicle; and determining, by the at least one unmanned aerial vehicle or the base station, the communication operation of the at least one unmanned aerial vehicle based on the operational information or the traffic information of the at least one unmanned aerial vehicle.

### CROSS-REFERENCE TO RELATED APPLICATIONS

This application claims priority to Korean Patent Applications No. 10-2023-0172824, filed on Dec. 1, 2023, No. 10-2024-0047612, filed on Apr. 8, 2024, and No. 10-2024-0166400, filed on Nov. 20, 2024, with the Korean Intellectual Property Office (KIPO), the entire contents of which are hereby incorporated by reference.

### BACKGROUND

### 1. Technical Field

The present disclosure relates to the technical field of communication systems based on unmanned aerial vehicles (UAVs), and more particularly, relates to communication technologies for acquiring and utilizing traffic information of UAVs.

### 2. Related Art

The content presented in this section serves solely as background information for the embodiments and does not represent any conventional technology.

UAVs are being utilized for a wide range of purposes, with their applications expected to expand further in the future.

As UAVs are employed for increasingly diverse purposes, the need for traffic control systems to reduce interference caused by UAV traffic is becoming more apparent.

To address this need, various technologies for UAV traffic control are being actively researched. Moreover, communication technologies for UAVs are also being developed to enhance their performance during traffic control processes.

Existing UAV traffic control technologies focus on areas such as UAV route planning, UAV movement control within designated routes, and communication systems for stable UAV operation. To enable such control technologies and communication system operations, various data, such as UAV mobility and traffic information across the operational area, are required, along with devices and networks to acquire this information. Furthermore, as such information is defined and utilized, communication techniques within UAV networks are likely to evolve as well.

### SUMMARY

To facilitate the utilization of traffic systems involving numerous UAVs in the future and the communication systems required for their operation, UAV traffic information, including UAV mobility and the overall traffic flow based on this mobility, is required.

It is an object of the present disclosure to define UAV operational information and traffic information within a designated region, which are required for UAV traffic and communication systems, and to provide a method and apparatus for acquiring such information.

It is another object of the present disclosure to provide communication techniques capable of using real-time UAV operational and traffic information within UAV network environments where UAV traffic information is defined and utilized.

According to a first exemplary embodiment of the present disclosure, an information acquisition and communication method for an unmanned aerial vehicle (UAV) may comprise: acquiring, by at least one first device, operational information or traffic information of the at least one unmanned aerial vehicle; providing, by the at least one first device, the operational information or the traffic information of the at least one unmanned aerial vehicle to the at least one unmanned aerial vehicle or to a base station affecting the communication operation of the at least one unmanned aerial vehicle; and determining, by the at least one unmanned aerial vehicle or the base station, the communication operation of the at least one unmanned aerial vehicle based on the operational information or the traffic information of the at least one unmanned aerial vehicle.

The acquiring of the operational information or traffic information of the at least one unmanned aerial vehicle may comprise: acquiring the operational information or traffic information of the at least one unmanned aerial vehicle within a sub-region; and obtaining the operational information or traffic information by collecting the operational information or traffic information of the at least one unmanned aerial vehicle within a super-region of the sub-region.

The acquiring of the operational information or traffic information of the at least one unmanned aerial vehicle may comprise: acquiring the operational information, including speed, altitude, or mobility of the at least one unmanned aerial vehicle; and acquiring the traffic information, including congestion or cluster information of the at least one unmanned aerial vehicle within a predetermined region, based on the operational information of the at least one unmanned aerial vehicle.

The determining of the communication operation of the at least one unmanned aerial vehicle based on the operational information or traffic information may comprise determining communication link adaptation between the base station and the at least one unmanned aerial vehicle based on the operational information or traffic information.

The determining of communication link adaptation between the base station and the at least one unmanned aerial vehicle based on the operational information or traffic information may comprise, determining communication link adaptation between the base station and the at least one unmanned aerial vehicle based on the operational information of the at least one unmanned aerial vehicle and channel status information between the base station and the at least one unmanned aerial vehicle, when the operational information of the at least one unmanned aerial vehicle is obtained.

The determining of communication link adaptation between the base station and the at least one unmanned aerial vehicle based on the operational information or traffic information may comprise, determining communication link adaptation between the base station and the at least one unmanned aerial vehicle based on the operational information, the traffic information, and channel status information between the base station and the at least one unmanned aerial vehicle, when the traffic information and operational information of the at least one unmanned aerial vehicle within a region to which the at least one unmanned aerial vehicle belongs is obtained.

The determining of communication link adaptation between the base station and the at least one unmanned aerial vehicle based on the operational information or traffic information may comprise, when the traffic information or operational information of the at least one unmanned aerial vehicle within a region to which the at least one unmanned aerial vehicle belongs is unavailable, determining communication link adaptation between the base station and the at least one unmanned aerial vehicle based on channel status information between the base station and the at least one unmanned aerial vehicle.

The determining of the communication operation of the at least one unmanned aerial vehicle based on the operational information or the traffic information may comprise determining whether to perform cooperative communication between the base station and a second base station to support the communication of the at least one unmanned aerial vehicle based on the operational information or the traffic information.

The determining of whether to perform cooperative communication between the base station and the second base station may comprise: predicting the communication performance based on available resources within a region to which the at least one unmanned aerial vehicle belongs; evaluating whether the predicted communication performance meets a required communication performance for the at least one unmanned aerial vehicle; and determining whether to perform cooperative communication between the base station and the second base station based on the evaluation result.

The determining of whether to perform cooperative communication between the base station and the second base station may further comprise determining a region to be provided with communication support and regions available for communication support using the cooperative communication.

According to a second exemplary embodiment of the present disclosure, a communication system for acquiring and utilizing information for at least one unmanned aerial vehicle (UAV) may comprise: at least one unmanned aerial vehicle; a base station affecting the communication operation of the at least one unmanned aerial vehicle; and at least one first device for acquiring the operational information or the traffic information of the at least one unmanned aerial vehicle, wherein the at least one first device provides the operational information or the traffic information of the at least one unmanned aerial vehicle to the at least one unmanned aerial vehicle or the base station, and the at least one unmanned aerial vehicle or the base station determines the communication operation of the at least one unmanned aerial vehicle based on the operational information or the traffic information of the at least one unmanned aerial vehicle.

The at least one first device may acquire the operational information or the traffic information of the at least one unmanned aerial vehicle within a sub-region, and obtains the operational information or traffic information by collecting the operational information or the traffic information of the at least one unmanned aerial vehicle within a super-region of the sub-region.

The at least one first device may acquire the operational information including speed, altitude, or mobility of the at least one unmanned aerial vehicle, and based on the operational information of the at least one unmanned aerial vehicle, may acquire the traffic information including congestion or cluster information of the at least one unmanned aerial vehicle within a predetermined region.

The at least one unmanned aerial vehicle or the base station may determine communication link adaptation between the base station and the at least one unmanned aerial vehicle based on the operational information or traffic information.

Upon obtaining the operational information of the at least one unmanned aerial vehicle, the at least one unmanned aerial vehicle or the base station may determine communication link adaptation between the base station and the at least one unmanned aerial vehicle based on the operational information of the at least one unmanned aerial vehicle and channel status information between the base station and the at least one unmanned aerial vehicle.

Upon obtaining the traffic information and the operational information of the at least one unmanned aerial vehicle within a region to which the at least one unmanned aerial vehicle belongs, the at least one unmanned aerial vehicle or the base station may determine communication link adaptation between the base station and the at least one unmanned aerial vehicle based on the operational information, traffic information, and channel status information between the base station and the at least one unmanned aerial vehicle.

The at least one unmanned aerial vehicle or the base station, when the traffic information or operational information of the at least one unmanned aerial vehicle within the region to which the at least one unmanned aerial vehicle belongs is unavailable, may determine communication link adaptation between the base station and the at least one unmanned aerial vehicle based on the channel status information between the base station and the at least one unmanned aerial vehicle.

The communication system may further comprise a second base station, wherein the at least one unmanned aerial vehicle, the base station, or the second base station may determine whether to perform cooperative communication between the base station and the second base station to support communication of the at least one unmanned aerial vehicle based on the operational information or traffic information.

The at least one unmanned aerial vehicle, the base station, or the second base station may predict communication performance based on available resources within a region to which the at least one unmanned aerial vehicle belongs, may evaluate whether the predicted communication performance meets a required communication performance for the at least one unmanned aerial vehicle, and may determine whether to perform cooperative communication between the base station and the second base station based on the evaluation result.

The at least one unmanned aerial vehicle, the base station, or the second base station may determine a region to be provided with communication support and regions available for communication support using the cooperative communication.

The future will witness a significant increase in the number and variety of UAV applications. The expansion of UAV operations underscores the importance of effective UAV flight control and communication systems.

According to an embodiment of the present disclosure, it is advantageous to define the information required for UAV traffic control and communication systems to safely and efficiently support future UAV operations.

According to an embodiment of the present disclosure, it is advantageous to classify and define the information required for UAV traffic control and communication systems into two categories: UAV operational information and UAV traffic information.

According to an embodiment of the present disclosure, it is advantageous to implement a device and method for acquiring UAV operational and traffic information.

According to an embodiment of the present disclosure, it is advantageous to implement a device and method for acquiring UAV operational and traffic information, considering UAV mobility and the ease of information utilization.

According to an embodiment of the present disclosure, it is advantageous to provide a UAV communication system capable of improving efficiency based on UAV movement within a designated region, using communication techniques grounded in UAV operational and traffic information.

### BRIEF DESCRIPTION OF DRAWINGS

FIG. 1 is a signal flow diagram illustrating the information acquisition and communication method for UAVs according to an embodiment of the present disclosure.

FIG. 2 is a block diagram conceptually illustrating the configuration of a device for observing and collecting the operational information of a UAV according to an embodiment of the present disclosure.

FIG. 3 is a signal flow diagram illustrating the process of acquiring operational information of a UAV according to an embodiment of the present disclosure.

FIG. 4 is a conceptual diagram illustrating the hierarchical configuration of a region configured to acquire traffic information according to an embodiment of the present disclosure.

FIG. 5 is a block diagram illustrating a device for acquiring, collecting, processing, analyzing, and/or generating traffic information of a UAV according to an embodiment of the present disclosure.

FIG. 6 is a conceptual diagram of the hierarchical configuration of regions and corresponding devices configured to acquire traffic information according to an embodiment of the present disclosure.

FIG. 7 is a conceptual diagram illustrating UAV traffic information configured in a path-specific manner within a region according to an embodiment of the present disclosure.

FIG. 8 is a conceptual diagram illustrating the process of determining and operating a link adaptation method utilizing the operational information and/or traffic information of a UAV according to an embodiment of the present disclosure.

FIG. 9 is a conceptual diagram illustrating the process of performing cooperative communication between base stations according to an embodiment of the present disclosure.

FIG. 10 is a flowchart illustrating the process of performing cooperative communication between base stations according to an embodiment of the present disclosure.

FIG. 11 is a conceptual diagram illustrating a generalized computing system in which UAVs, first and second base stations, and/or information acquisition and transmission devices, capable of performing at least some of the processes from FIGS. 1 to 10, are implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even a technology known before the filing date of the present application may be included as a part of the configuration of the present disclosure when necessary, and will be described herein without obscuring the spirit of the present disclosure. However, in describing the configuration of the present disclosure, the detailed description of a technology known before the filing date of the present application that those of ordinary skill in the art can clearly understand may obscure the spirit of the present disclosure, and thus a detailed description of the related art will be omitted.

However, the purpose of the present disclosure is not to claim rights to these known technologies, and the content of the known technologies may be included as part of the present disclosure within the scope not departing from the spirit of the present disclosure.

Hereinafter, exemplary embodiments of the present disclosure will be described in more detail with reference to the accompanying drawings. In order to facilitate overall understanding when describing the present disclosure, the same reference numerals are used for the same elements in the drawings, and overlapping descriptions of the same elements are omitted.

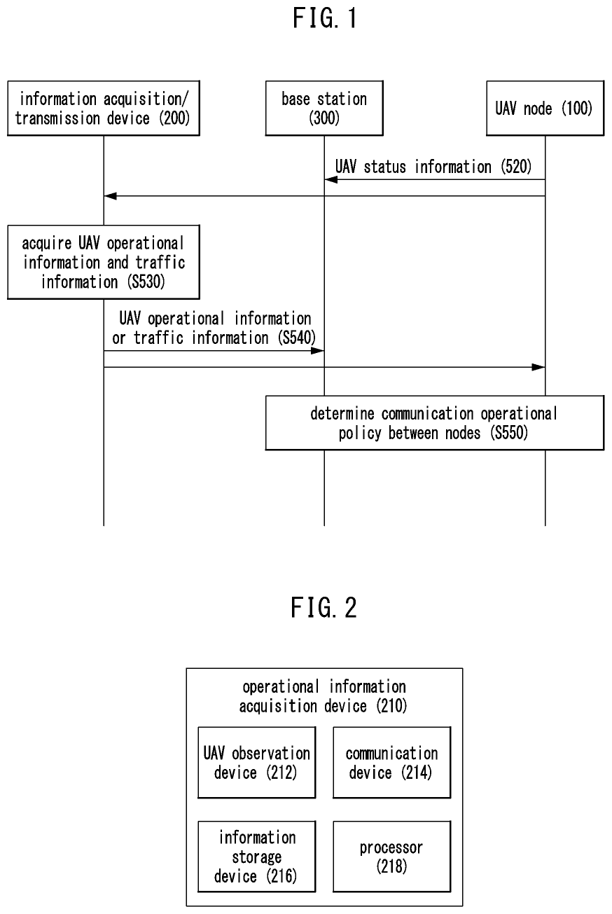

With reference to the embodiments of FIGS. 1 to 11, the present disclosure is generally composed of the following steps.

Step of acquiring UAV traffic information and operational information (see FIGS. 1 to 7, and 11)

Step of operating the UAV communication network using UAV traffic and operational information (see FIGS. 1, 8 to 11)

FIG. 1 is a signal flow diagram illustrating the information acquisition and communication method for UAVs according to an embodiment of the present disclosure.

With reference to FIG. 1, the information acquisition and communication method for at least one UAV, according to an embodiment of the present disclosure, may be performed by a communication system that includes at least one information acquisition/transmission device 200 as the first device, at least one UAV node 100, and at least one base station 300 that affects the communication operation of the UAV node 100.

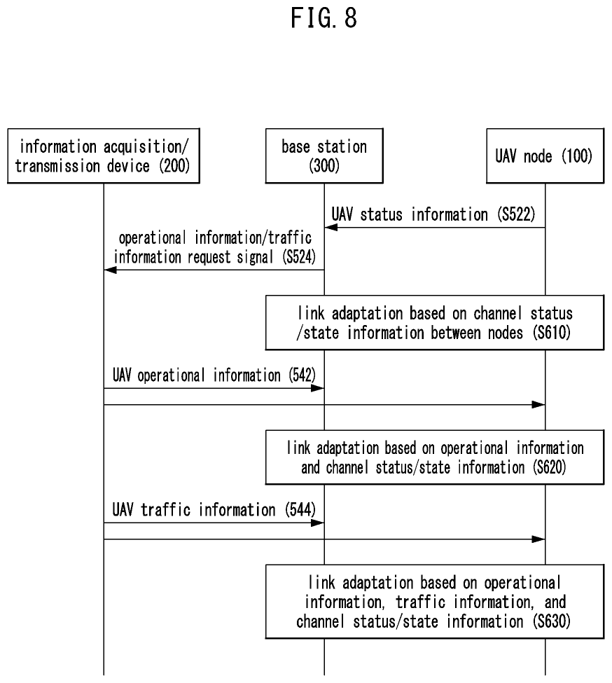

With reference to FIG. 1, the method may include acquiring, by the at least one first device 200, the operational information or traffic information of the at least one UAV 100 in operation S530, providing, by the at least one first device 200, the operational or traffic information of the at least one UAV 100 to the at least one UAV 100 or the at least one base station 300 affecting the communication operation of the at least one UAV 100 in operation S540, and determining, by the at least one UAV 100 or the base station 300, the communication operation of the at least one UAV 100 based on the operational or traffic information of the at least one UAV 100 in operation S550. According to an embodiment of the present disclosure, the method may include determining a policy for communication operation in operation S550. Examples of the policy for communication operation may include determining communication link adaptation (or determining policies for communication link adaptation) as shown in FIGS. 2 to 7 or determining whether to perform cooperative communication between base stations by obtaining support from other base stations as shown in FIGS. 8 to 10.

The acquiring of the operational or traffic information of the at least one UAV 100 in operation S530 may include acquiring the operational or traffic information of the at least one UAV 100 within a sub-region, and acquiring the operational or traffic information of the at least one UAV 100 by collecting the information within a super-region of the sub-region.

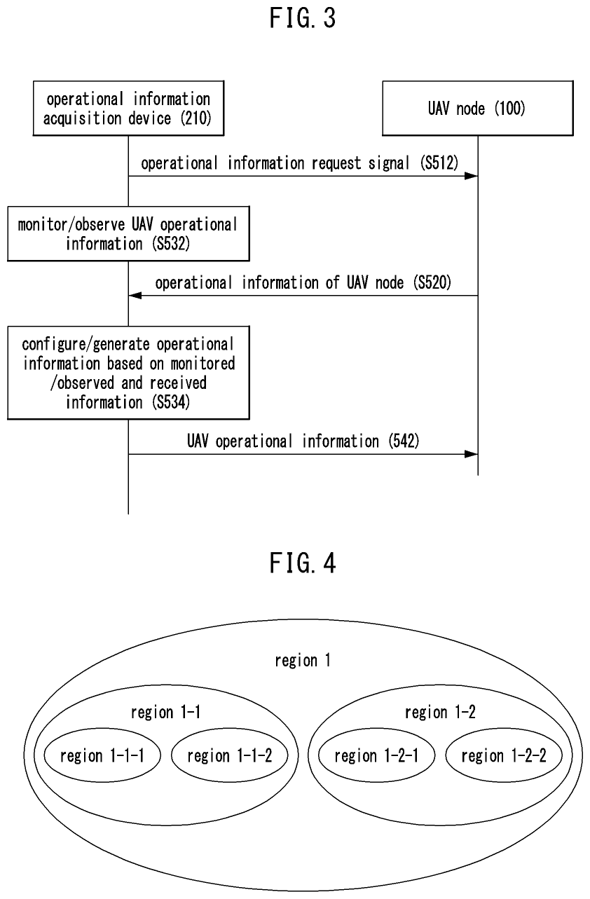

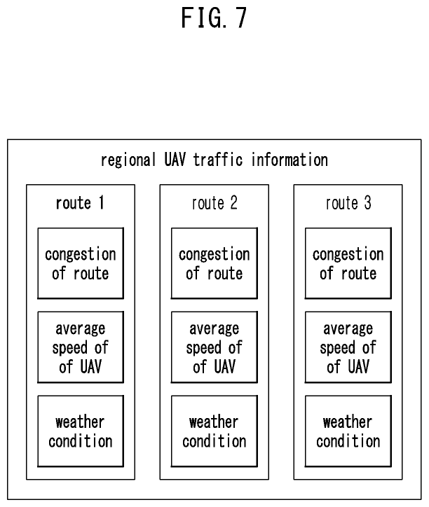

The acquiring of the operational or traffic information of the at least one UAV 100 in operation S530 may include acquiring operational information such as speed (or velocity), altitude, and/or mobility of the at least one UAV 100 (refer to S532 and S534 in FIG. 3), and, based on the operational information of the at least one UAV 100, acquiring traffic information including congestion or clustering information of the at least one UAV 100 within a predetermined region (refer to FIG. 6 and FIG. 7).

The determining of a policy for the communication operation of the at least one UAV 100 based on operational or traffic information in operation S550 may include determining a communication link adaptation policy between the base station 300 and the at least one UAV 100 based on operational or traffic information (refer to S610, S620, and S630 in FIG. 8).

The determining of a communication link adaptation policy between the base station 300 and the at least one UAV 100 based on operational or traffic information may include, when the operational information of the at least one UAV 100 is obtained, determining the communication link adaptation policy based on a) the operational information between the base station 300 and the at least one UAV 100, and b) the channel status/state information between the base station 300 and the at least one UAV 100 (refer to S620 in FIG. 8).

The determining of a communication link adaptation policy between the base station 300 and the at least one UAV 100 based on operational or traffic information may include, when the traffic and operational information of the at least one UAV 100 within the region to which the at least one UAV 100 belongs is obtained, determining the communication link adaptation policy based on a) operational information between the base station 300 and the at least one UAV 100, b) traffic information, and c) channel status/state information between the base station 300 and the at least one UAV 100 (refer to S630 in FIG. 8).

The determining of a communication link adaptation policy between the base station 300 and the at least one UAV 100 based on operational or traffic information may include, when the traffic or operational information of the at least one UAV 100 within the region to which the at least one UAV 100 belongs cannot be utilized, determining the communication link adaptation policy between the base station 300 and the at least one UAV 100 based on channel status/state information between the base station 300 and the at least one UAV 100 (refer to S610 in FIG. 8).

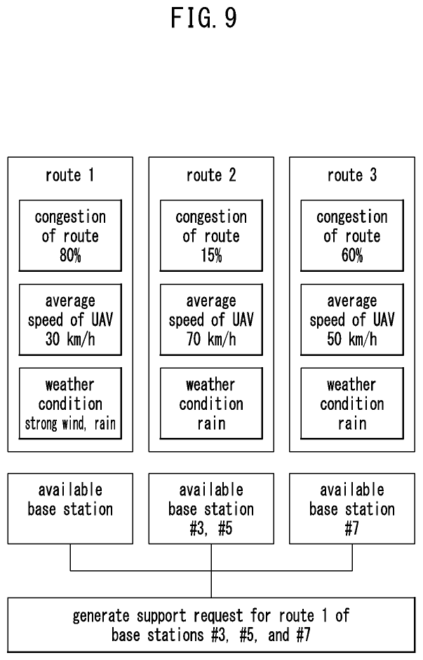

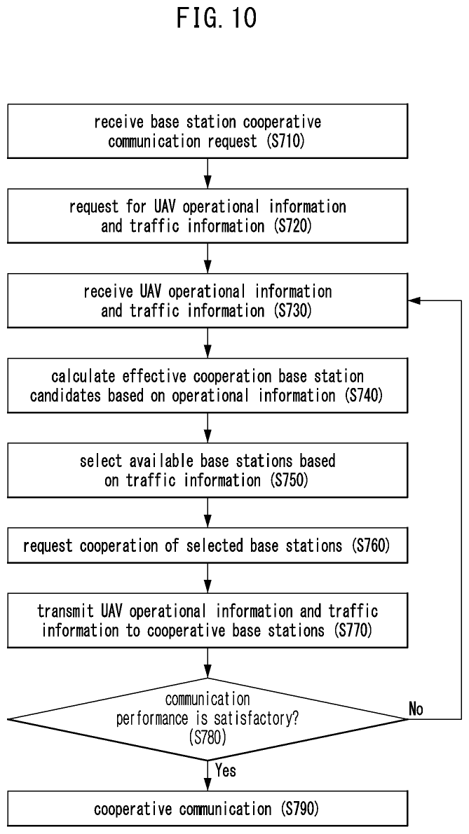

The determining of a policy for the communication operation of the at least one UAV 100 based on operational or traffic information in operation S550 may include, based on the operational or traffic information, determining whether to perform cooperative communication between the base station 300 and a second base station (not shown) other than base station 300 in order to support the communication of the at least one UAV 100 (refer to FIG. 9 and FIG. 10).

The determining of whether to perform cooperative communication between base station 300 and a second base station may include predicting the communication performance based on the available resources within the region to which the at least one UAV 100 belongs (refer to S740 to S770 in FIG. 10), evaluating/estimating whether the predicted communication performance meets the communication performance requirements for the at least one UAV 100 (refer to S780 in FIG. 10), and, based on the evaluation/estimation/assessment result, determining whether to perform cooperative communication between base station 300 and the second base station (refer to S780 in FIG. 10).

The determining of whether to perform cooperative communication between base station 300 and a second base station may further include determining the region to be provided with communication support using cooperative communication, and the regions available for communication support using cooperative communication (refer to S740, S750, and S760 in FIG. 10).

According to an embodiment of the present disclosure, the communication system for acquiring and utilizing information for at least one UAV 100 may include at least one UAV 100, at least one base station 300 affecting the communication operation of the at least one UAV 100, and at least one first device 200 that acquires the operational information and/or traffic information of the at least one UAV 100 in operation S530.

In the communication system according to an embodiment of the present disclosure, the at least one first device 200 may provide the operational information or traffic information of the at least one UAV 100 to the at least one UAV 100 and/or the base station 300 in operation S540.

In the communication system according to an embodiment of the present disclosure, the at least one UAV 100 and/or base station 300 may determine a policy for the communication operation of the at least one UAV 100 based on the operational information or traffic information of the at least one UAV 100 in operation S550.

The at least one first device 200 may acquire the operational or traffic information of the at least one UAV 100 within a sub-region, and acquire the operational or traffic information by collecting the information of the at least one UAV 100 within a super-region of the sub-region.

The at least one first device 200 may acquire operational information including speed, altitude, or mobility of the at least one UAV 100, and based on the operational information of the at least one UAV 100, acquire traffic information including congestion or clustering information of the at least one UAV 100 within a predetermined region.

In the communication system according to an embodiment of the present disclosure, the at least one UAV 100 and/or base station 300 may determine a communication link adaptation policy between the base station 300 and the at least one UAV 100 based on operational or traffic information.

In this case, when the operational information of the at least one UAV 100 is obtained, the at least one UAV 100 and/or base station 300 may determine the communication link adaptation policy between the base station 300 and at least one UAV 100 based on a) the operational information between the base station 300 and at least one UAV 100, and b) the channel status information between the base station 300 and at least one UAV 100.

In the communication system according to an embodiment of the present disclosure, the at least one UAV 100 and/or base station 300 may determine a communication link adaptation policy between the base station 300 and the at least one UAV 100 based on a) operational information between the base station 300 and at least one UAV 100,
b) traffic information, and c) channel status information between the base station 300 and at least one UAV 100,
when the traffic and operational information of the at least one UAV 100 within the region to which the at least one UAV 100 belongs has been obtained.

The at least one UAV 100 and/or base station 300 may also determine the communication link adaptation policy between the base station 300 and the at least one UAV 100 based on the channel status information between the base station 300 and at least one UAV 100, when the traffic or operational information of the at least one UAV 100 within the region to which the at least one UAV 100 belongs cannot be utilized.

The communication system according to an embodiment of the present disclosure may further include a second base station, in addition to the base station 300. In this case, the at least one UAV 100, base station 300, and/or second base station may determine whether to perform cooperative communication between the base station 300 and the second base station to support the communication of the at least one UAV 100 based on operational or traffic information.

In this case, the at least one UAV 100, base station 300, or second base station may predict the communication performance based on available resources within the region to which the at least one UAV 100 belongs, evaluate/estimate whether the predicted communication performance meets the communication performance requirements for the at least one UAV 100, and, based on the evaluation/estimation/assessment results, determine whether to perform cooperative communication between the base station 300 and the second base station.

In this case, the at least one UAV 100, base station 300, or second base station may determine a region to be provided with communication support using cooperative communication and the regions available for communication support using cooperative communication.

In the embodiment of FIG. 1, the UAV 100 may transmit its status information to the base station 300 and/or the first device 200 in operation S520. Operation S520 may be performed upon request from the first device 200 and/or base station 300 or according to a predetermined schedule (time, order, or sequence).

FIG. 2 is a block diagram conceptually illustrating the configuration of a device for observing and collecting the operational information of a UAV according to an embodiment of the present disclosure.

FIG. 2 illustrates the device performing the process of acquiring the operational information of the UAV. The operational information acquisition device 210 may include a UAV observation device 212, a communication device 214, an information storage device 216, and a processor 218.

The processor 218 may control the operation of the UAV observation device 212, communication device 214, and information storage device 216 by executing program instructions, and manage the process of acquiring the operational information of the UAV.

In an embodiment of the present disclosure, managing, coordinating, and controlling the mobility of UAVs may be required for operating multiple UAVs within an airspace. The UAV traffic information within the region may refer to both physical information such as the number, speed, and position of UAVs in the region, as well as information that can be derived from processing this data, such as the congestion of existing routes and information about UAV clusters, which can affect the operation, control, and communication of UAVs within the region.

The operational information of a UAV may include information that can affect the operation, control, and communication of each UAV entity, such as the mobility (e.g., speed, altitude), available power, jitter information, and fuel information of the UAV.

The traffic information of UAVs within a region may be obtained by collecting the operational information of each UAV entity within the region and processing the information into usable information through various methods such as calculation, statistics, machine learning, AI, etc., based on the actual movements of the UAVs in the region. The method of observing and collecting the operational information of the UAV entity, as the smallest unit of traffic information, can be divided into two approaches: one in which each UAV entity transmits its own operational information for a device to receive and acquire, and another in which a separate device observes and measures the UAV to acquire its operational information; both approaches can be combined to constitute and acquire the operational information of the UAV.

The methods and configurations for collecting the operational information of each UAV entity in a region can vary. A centralized network can be constructed by gathering the operational information of all UAV entities within the region in one place, thus acquiring the UAV traffic information for the entire region. Alternatively, a distributed network can be established by collecting the operational information of UAV entities within smaller sub-regions, acquiring traffic information for each sub-region, and then aggregating it to obtain the overall UAV traffic information for the entire region. In an embodiment of the present disclosure, a suitable UAV traffic information acquisition network can be configured according to the characteristics of the region using various methods.

The number and content of UAV operational information required for processing traffic information may vary. While the most accurate traffic information can be obtained by collecting operational information from all UAVs in the region, there may be cases where the available UAV operational information is limited. In cases where the available UAV operational information is limited, existing traffic data statistics or artificial intelligence (AI) can be utilized to obtain the UAV operational information.

By collecting, analyzing, and processing UAV operational information within the region, predetermined UAV paths can be considered when generating traffic information. When the UAV path within the region is predetermined, traffic information can be acquired and organized according to that path. UAVs following a predetermined route have a specific direction of mobility, so traffic information for the route can be obtained with less operational information, and the overall UAV traffic information can be divided and organized by route.

The configuration of UAV traffic information may vary depending on the location of the region. UAV traffic information may vary in terms of content and data size depending on whether the region is urban, suburban, or marine.

Depending on the application of the UAV, the required latency, data speed, and other communication performance requirements may vary, and the configuration of the UAV traffic information may change according to these communication performance requirements.

The UAV traffic information within the region may be updated periodically and, when needed, updated sporadically.

With reference to FIG. 1 again, as part of the UAV communication network operation process using UAV traffic and/or operational information, a communication operational policy may be determined between nodes in operation S550.

UAV operational information and traffic information may be used to facilitate the operation of the UAV communication network. The UAV communication network may include all links for exchanging data between nodes in the network, control signals to coordinate and control UAV movements, UAV operational information, and traffic information. The transmission and reception technique between UAV nodes and base station nodes may be determined based on UAV operational information and/or traffic information. Communication between the UAV and other nodes in the region may be categorized into two scenarios depending on the entity utilizing the information, and within each scenario, the operation may be divided further depending on the availability of the information.

The first scenario may involve the utilization of information by system nodes.

The system nodes communicating with the UAV may include ground base stations, aerial base stations, ground or aerial devices that transmit control signals to the UAV, and devices equipped with units for acquiring the aforementioned information. A system node may be an entity that receives UAV operational information or traffic information from other nodes, or one that independently obtains this information. These system nodes, in communication with the UAV, may support the UAV node by using the operational information of the connected UAV and traffic information within the region. The transmission and reception techniques may vary depending on the availability of two types of information. These techniques may include beamforming decisions at base stations, link adaptation, channel estimation, antenna rotation, etc.

When a system node supports a UAV node and is unable to utilize UAV operational information and regional traffic information, the base station maintains the previous transmission and reception techniques.

When the system node can utilize UAV operational information, the node may determine the transmission and reception techniques accordingly.

When both UAV operational information and traffic information are available, the system node may use both to determine the transmission and reception techniques.

The first scenario may involve the utilization of information by UAV nodes.

A UAV node may receive UAV operational information or traffic information from other nodes, and for some operational information, the UAV node may independently acquire the information. The UAV node may determine the transmission and reception techniques by utilizing its own operational information and traffic information within the region. Since the UAV can always use some of its operational information, the determination of transmission and reception techniques may vary depending on the availability of regional traffic information. These transmission and reception techniques may include the UAV's beamforming decisions, link adaptation, channel estimation, antenna rotation, and so on.

When the regional traffic information is unavailable for communication with a system node, the UAV may determine the transmission and reception techniques based on its own operational information.

When the regional traffic information is available for communication with a system node, the UAV may determine the transmission and reception techniques based on its own operational information and the regional traffic information.

The UAV may also utilize operational information obtained from external nodes, in addition to its own operational information, to determine the transmission and reception techniques.

The determination of these techniques may be dynamically performed, considering factors such as the periodicity and accuracy of the information. The UAV may choose between traditional transmission and reception techniques without information utilization, information-based techniques, or a hybrid approach, depending on the accuracy of the available information. Additionally, when current information is unavailable, the information from a previous time may be used.

The use of information by the two nodes may be determined based on their respective situations. In such cases, one node may use the information, both nodes may use the information, or neither node may use the information. Depending on the situation, when one node acquires information, the corresponding node may transmit the information to the other node, allowing both nodes to use the information to determine the transmission and reception techniques.

With reference to FIGS. 1 and 2 again, the UAV traffic information and operational information may be acquired in operation S530.

Examples of UAV operational information include the UAV's speed (or velocity), altitude, position, expected route, required latency, required data rate, and available power, while the regional traffic information may include the number of UAVs per route, the average speed (or average velocity) of UAVs, and the density of UAVs in the region. The devices and procedures for acquiring operational and traffic information are illustrated in FIGS. 2 to 7.

With reference to FIG. 2 again, the UAV operational information is composed of information that can be obtained from the UAV itself and information that can be obtained through external observation. Examples of information that a UAV can obtain on its own include its speed (or velocity), location, fuel status (or fuel level), power, required delay time, required data rate, and current channel state, and this information may be transmitted not only to the nodes currently in communication but also to various external nodes and devices. Information about the UAV may also be obtained through external devices outside of the UAV. The information may be gathered through devices that observe and measure the movement of the UAV. The operational information acquisition device observes and measures nearby UAVs through observation devices to obtain information, receives the information autonomously gathered by the UAVs, and constructs and collects operational information for all UAVs within the observable or receivable range.

FIG. 2 illustrates a device for observing and collecting UAV operational information, which may include a device capable of observing and measuring the physical attributes such as speed and position of external UAVs, a communication device for transmitting and receiving UAV signals to and from another device, a storage device for storing the measured and collected information, and a processor. The device may be incorporated into a ground base station or a separate ground terminal and may also be included and operated in an aerial terminal or an aerial base station.

The operational information acquisition device 210 may generate UAV operational information by collecting both the observational data from the observation device 212 and the information autonomously gathered by the UAV (see S520 in FIG. 1 and FIG. 3).

FIG. 3 is a signal flow diagram illustrating the process of acquiring operational information of a UAV according to an embodiment of the present disclosure.

With reference to FIG. 3, the process of acquiring UAV operational information is conceptually illustrated. FIG. 3 is a signal flow diagram illustrating the method for the device 210 to acquire operational information of a UAV. In operation S512, the device 210 periodically transmits a signal, which can take various forms including a pilot signal, to initiate information collection in the surrounding regions. Subsequently, the device may observe the UAV to monitor and measure UAV operational information in operation S532. Upon receiving the operational information request signal from the device 210, the UAV 100 may respond by transmitting its autonomously gathered operational information to the device in operation S520. In operation S534, the device 210 may configure or generate UAV operational information based on the information obtained through responses in S520 and observations in S532. This constructed operational information may be transmitted back to the UAV 100 in operation S542 for use by the UAV 100. The above-described operations for acquiring operational information are solely illustrative, and the sequence of operations may vary depending on the performance or the given situation of the device. For example, when the observation device and communication device can operate simultaneously, or separately (individually), or operations S532 and S520 may occur concurrently.

Examples of the UAV information constructed by the device 210 may include the UAV's position, speed, altitude, degree of wobble, information about the cluster to which the UAV belongs, fuel status, Doppler shift magnitude obtained through processing such information, and channel information between the device and the UAV.

FIG. 4 is a conceptual diagram illustrating the hierarchical configuration of a region configured to acquire traffic information according to an embodiment of the present disclosure.

The traffic information of UAVs within a region may be obtained by processing the operational information of each UAV entity collected within the region. The methods and configurations for collecting the operational information of each UAV entity in a region can vary. One example is the use of a hierarchical configuration that allows for the efficient information utilization collection within smaller regions (Region 1-1, Region 1-2) of a larger region (Region 1). In the hierarchical configuration, the region in which the network operates is divided into multiple layers, with higher layer regions encompassing the lower layer regions.

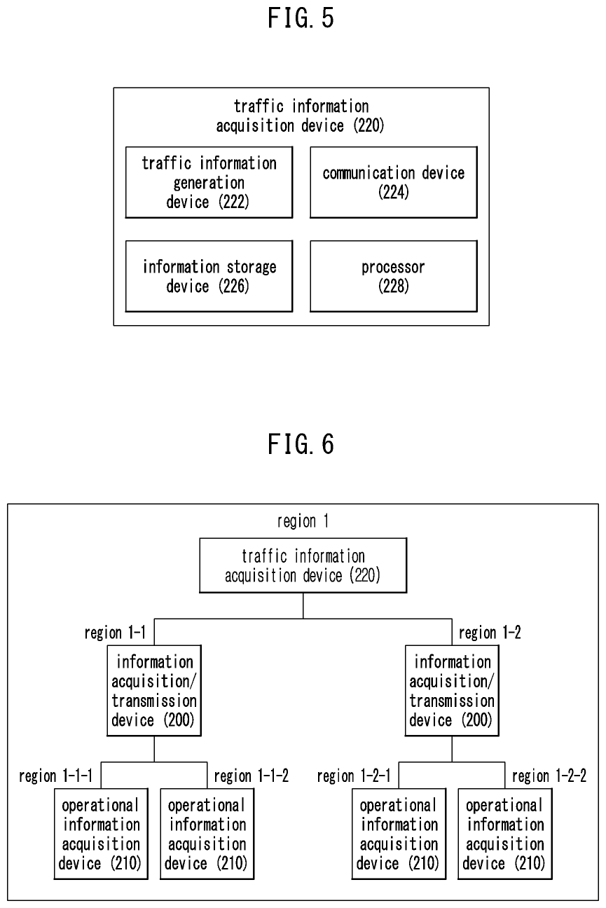

FIG. 4 illustrates a planar representation of a region of a region managed by a network, which includes the first device 200. The first device 200 may conceptually include the operational information acquisition device 210, the traffic information acquisition device (refer to 220 in FIG. 5), and a device for acquiring/transmitting information (not shown).

In the embodiment of FIG. 4, a specific region is composed hierarchically of multiple sub-regions and regions 1-A-B. In FIG. 4, regions 1-A-B represents the lowest layer in this hierarchical configuration, and the aforementioned operational information acquisition device acquires and collects operational information of UAVs within regions 1-A-B. The operational information of the UAVs in regions 1-A-B, acquired from this device, may be used within regions 1-A-B or exchanged with devices managing higher-layer regions. Similarly, through the exchange of information between layers, the highest-layer regions may collect, store, and process all operational information within the region. The division of regions for such a hierarchical configuration may vary depending on the configuration and performance of the devices composing the network. For example, the aforementioned devices observe and collect the operational information of UAVs in the surrounding regions, and the size of the lowest-layer region 1-A-B managed by the device may be determined based on the power used by the device, the antenna architecture/structure of its internal communication device, etc.

Furthermore, due to the nature of UAVs, the region division may take the form of three-dimensional spaces, and the shapes may vary depending on the terrain, the type of UAV, and other factors, such as cylindrical, hexagonal, or spherical shapes. The hierarchical configuration allows for flexible region divisions based on specific circumstances. Information exchange between layers may occur through both wired and wireless methods, depending on the device.

FIG. 5 is a block diagram illustrating a device for acquiring, collecting, processing, analyzing, and/or generating traffic information of a UAV according to an embodiment of the present disclosure.

With reference to FIG. 5, a device 220 for acquiring traffic information of a UAV is illustrated. The operational information acquisition device 220 may include a traffic information generation/configuration device 222, a communication device 224, an information storage device 226, and a processor 228.

The processor 228 may control the operation of the traffic information generation/configuration device 222, the communication device 224, and the information storage device 226 by executing program instructions, and manage the process of generating/acquiring/configuring the traffic information of the UAV.

FIG. 5 shows an example of a configuration of a device for acquiring traffic information, which includes a communication device 224 for receiving operational information from lower-layer devices and transmitting the acquired traffic information to other nodes and devices, a traffic information processing device 222 for processing the collected operational information into traffic information, an information storage device 226 for storing information, and a processor 228 for device operation.

FIG. 6 is a conceptual diagram of the hierarchical configuration of regions and corresponding devices configured to acquire traffic information according to an embodiment of the present disclosure.

FIG. 6 illustrates a hierarchical configuration of the devices in correspondence to the hierarchical configuration of the regions depicted in FIG. 4.

In the lowest layer, the region 1-A-B, the operational information acquisition device 210 may acquire and/or store the operational information of UAVs in region 1-A-B and may transmit/forward this information either to the UAVs within the super-region (for example, region 1-A or region 1) or to devices in higher layers. At the highest layer, the traffic information acquisition device 220 may receive UAV operational information from lower layers and processes the information into traffic information for the region, thereby acquiring the traffic information of the region. Devices in intermediate layers, such as those in region 1-1 may acquire UAV operational information from the operational information acquisition devices 210 in the sub-regions 1-A-B, and the operation of the network may vary depending on the configuration of these devices.

When the device 200 in the intermediate layer is configured with communication devices and storage devices for information transmission, reception, and storage, the network operates in a centralized manner, with all UAV traffic information from regions 1-A-B being acquired by the traffic information acquisition device 220 at the highest layer and transmitted from this device to the devices in the lower layers. Conversely, when the device 200 in the intermediate layer is configured as a traffic information acquisition device 220 that collects and processes information from lower layers to acquire, store, and transmit traffic information within the hierarchical regions, the network operates in a distributed manner, enabling the utilization of traffic information from smaller regions, with the highest layer collecting traffic information from lower layers to obtain the overall traffic information for the region.

When processing UAV traffic information within a region, infrastructure information within the region can be utilized. This infrastructure information may include predetermined UAV paths in the region and the locations of ground base stations that can support the region. By utilizing path information within the region, UAV traffic information specialized for the UAV path can be acquired and configured. In cases where UAVs in a specific region operate along a specific path, the required amount of information to be acquired from the operational information acquisition device in the subregion 1-A-B can be reduced. Furthermore, by configuring the traffic information to be specialized to path information, UAV paths within the region can be effectively managed.

FIG. 7 is a conceptual diagram illustrating UAV traffic information configured in a path-specific manner within a region according to an embodiment of the present disclosure.

FIG. 7 illustrates the UAV traffic information configured in a path-specific manner for a region, where the traffic information acquisition device configures the UAV traffic information for each path. This traffic information configuration takes an efficient form for UAV path operations within a region by providing only the traffic information for the required path when transmitting traffic information to other nodes.

With reference to FIG. 7, information such as path congestion, average speed (or average velocity), and weather conditions may be differentiated for each UAV path.

Additionally, the UAV traffic and operational information may be applied in the UAV communication network operation phase, as seen in operation S550 of FIG. 1.

The devices and methods proposed in the embodiments of FIGS. 1 through 7 allow for the use of the acquired UAV traffic and operational information in the operation of the UAV communication network. Embodiments of the present disclosure propose methods for using the information above in link adaptation (FIG. 8) and base station cooperative communication (FIGS. 9 and 10) as communication techniques between base station nodes and UAV nodes within the communication network.

FIG. 8 is a conceptual diagram illustrating the process of determining and operating a link adaptation method utilizing the operational information and/or traffic information of a UAV according to an embodiment of the present disclosure.

With reference to FIG. 8, the UAV operational information and traffic information within the region may be utilized for the link adaptation method between nodes.

FIG. 8 illustrates an example of determining and operating a link adaptation method using the UAV operational information and traffic information.

The UAV node 100 may transmit the UAV status information to the base station 300 in operation S522, and the base station 300 may transmit a request signal for operational information and traffic information to the first device 200 in operation S524.

When the UAV operational information and traffic information within the region cannot be utilized (either because the operational/traffic information cannot be obtained or because the first device 200 has not yet responded with the operational/traffic information), the link adaptation between the two nodes (the base station 300 and the UAV node 100) may proceed using the conventional link adaptation method, which relies on the channel status/state information between the two nodes, in operation S610. Even after operation S610, the base station 300 may request the operational information and traffic information signal of the UAV 100 from the information transmission device in operation S524. In FIG. 8, the first device 200 may be the operational information acquisition device 210, the traffic information acquisition device 220, or a separate device that receives and transmits information from both of these types of devices.

Before the information arrives in response to the information request transmitted in operation S524, the conventional link adaptation method is applied in operation S610, and when the UAV operational information arrives first at the base station 300 and UAV 100 in operation S542 and becomes available for use in communication between the base station 300 and UAV node 100, the first link adaptation method utilizing the UAV operational information may be used in operation S620. The first link adaptation method utilizes not only the existing UAV channel status/state information but also the UAV operational information, such as its location and speed (or velocity), to calculate the distance and Doppler shift between the two nodes for the next link adaptation time, and incorporates these factors into the channel status/state information to make more information available for link adaptation. Additionally, responses to transmission failures or successes may also be used to efficiently determine link adaptation. For example, the UAV operational information, which helps assess the received signal strength between the two nodes, may be reflected in link adaptation.

During communication between the two nodes, when UAV traffic information is transmitted in operation S544 and both UAV operational information and traffic information become available, the second link adaptation method, using both of these pieces of information, may be applied in operation S630. The second link adaptation method, by utilizing traffic information to determine the number of UAVs adjacent to the UAV, can assess the level of interference arriving at the UAV during communication, thereby enabling the evaluation/estimation/assessment of the received signal strength and the signal-to-interference-plus-noise ratio between the two nodes. Therefore, the second link adaptation method can perform link adaptation more precisely than the first link adaptation method.

FIG. 9 is a conceptual diagram illustrating the process of performing cooperative communication between base stations according to an embodiment of the present disclosure.

FIG. 10 is a flowchart illustrating the process of performing cooperative communication between base stations according to an embodiment of the present disclosure.

In cases where a UAV requires high performance or when supporting a cluster of UAVs, communication through a single base station node may be insufficient. In such cases, additional base station nodes in the vicinity may be utilized to support UAV nodes through cooperation between base stations (refer to FIG. 9), where UAV operational information and traffic information may be used to facilitate cooperative communication between base stations.

The cooperative communication between base stations may be managed by a separate management device, by one of the base stations, or jointly by multiple base stations collaborating to manage the cooperative communication.

With reference to FIGS. 9 and 10, cooperative communication between base stations may include all operations in which base stations other than the one supporting a specific UAV within a region transmit signals or assist communication for that UAV, and all operations in which base stations other than those supporting UAVs within a specific region transmit signals or assist communication for the specific region.

Cooperative communication between base stations based on UAV traffic information may operate either as determined by a central device according to UAV traffic information or upon the request of communicating base stations and terminals. Here, the device acquiring and configuring traffic information may predict network conditions within a region and identify available resources based on the traffic information.

As described above, the device acquiring and configuring traffic information may predict network conditions within a region and identify available resources based on the traffic information. Here, the available resources within the traffic information may include the locations and numbers of base stations within the region, available frequency bands, and power levels within the region.

Based on the traffic conditions and available resource information within the traffic information, it is possible to evaluate the performance of the current communication system within the region and assess the extent of performance improvement achievable through cooperative communication utilizing the available resources. For example, the risk level for each region within the system may be evaluated based on the traffic information. The risk level may be calculated by considering various factors, including congestion within the region, weather conditions, quality-of-service (QoS) requirements for stable control signal transmission and reception, and the available resources within the region. In a region with high congestion and requiring high QoS for stable system control, when the predicted communication performance based on the available resources within the region falls short, the risk level of the region may be evaluated as a danger level. When the predicted communication performance based on QoS, considering factors such as congestion, and available resources within the region is adequate, the region may be evaluated as being at an appropriate level, and when the predicted performance based on the available resources exceeds that of the required QoS, the region may be evaluated as a surplus level, allowing the resources within such a region to be used to support other regions.

Based on the risk levels for each region, the base station cooperative communication management device may manage the cooperative communication between base stations. The operation of the cooperative communication may be determined according to the per-region risk levels, allowing for the distinction between regions that may receive communication support and regions that may provide such support. Additionally, the performance improvement from base station cooperative communication may be evaluated using available UAV operational information, regional traffic information, and overall system traffic information within the supported region. The degree of performance improvement may be calculated in various ways, such as by resolving performance gaps between regions or maximizing the performance of specific regions, and based on this, the most efficient cooperative base stations for communication may be selected.

FIG. 9 illustrates an example where the central device (or server) may generate a request for cooperation of neighbor base stations for target base station cooperative communication by utilizing the traffic information, such as that shown in FIG. 7, to request support from available base stations that can assist with different paths or regions.

The base station support request signal may include not only the support request but also the transmission and reception methods, appropriate communication frequencies, transmission power, support duration, and the signal itself that needs to be transmitted.

FIG. 10 is a flowchart illustrating the cooperative communication between base stations managed by a base station cooperative communication management device (or server), where a base station communicating with a UAV may request cooperative communication of the management device (server), which receives the request in operation S710 and requests the UAV operational information and regional UAV traffic information in operation S720. Here, the requested traffic information may comprehensively include traffic information for sub-regions, path-specific traffic information, and overall regional traffic information, depending on the situation.

The management device (server) may receive the UAV operational information in operation S730, calculate and identify the locations of potential cooperative base station candidates effective for improving UAV communication performance based on the UAV's location, speed (or velocity), altitude, and required performance in operation S740, select (or choose or determine) the available base stations from these candidates based on the current traffic situation in operation S750 upon receiving traffic information, and then request cooperative communication of the selected base stations in operation S760. The base station that requested cooperative communication may also transmit the UAVs operational information and traffic information to be utilized for the communication performance between the two nodes in operation S770.

The management device may determine in operation S780 whether the communication performance is satisfactory based on reports from the cooperating nodes, and when the performance does not meet the required level, the management device may search for additional cooperative base stations in operations S730 through S770 and continue cooperative communication in operation S790 to ensure satisfactory communication performance.

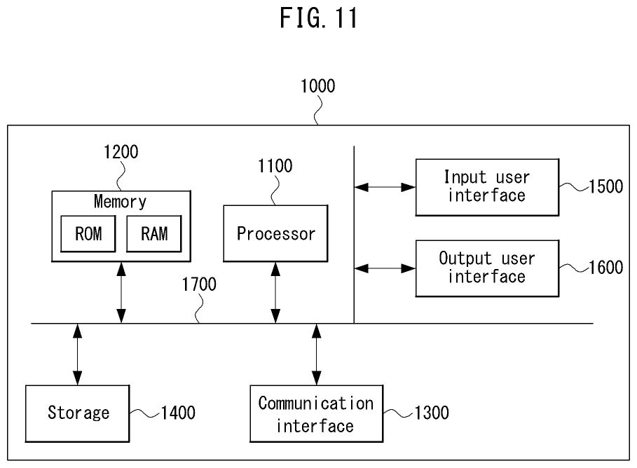

FIG. 11 is a conceptual diagram illustrating a generalized computing system in which UAVs, first and second base stations, and/or information acquisition and transmission devices, capable of performing at least some of the processes shown by FIGS. 1 to 10, are implemented.

At least some of the processes of the information acquisition and communication method for the UAV according to an embodiment of the present disclosure may be executed by the computing system 1000 of FIG. 11.

With reference to FIG. 11, the computing system 1000 according to an embodiment of the present disclosure may include a processor 1100, memory 1200, a communication interface 1300, storage 1400, an input user interface 1500, an output user interface 1600, and a bus 1700.

The computing system 1000, according to an embodiment of the present disclosure, may include at least one processor 1100 and a memory 1200 storing instructions for instructing the at least one processor 1100 to perform at least one step. At least some steps of the method according to an embodiment of the present disclosure may be performed by the at least one processor 1100 loading and executing instructions from the memory 1200.

The processor 1100 may refer to a central processing unit (CPU), a graphics processing unit (GPU), or a dedicated processor on which the methods according to embodiments of the present disclosure are performed.

Each of the memory 1200 and the storage device 1400 may be configured as at least one of a volatile storage medium and a non-volatile storage medium. For example, the memory 1200 may be configured as at least one of read-only memory (ROM) and random access memory (RAM).

Also, the computing system 1000 may include a communication interface 1300 for performing communication through a wireless network.

In addition, the computing system 1000 may further include a storage device 1400, an input interface 1500, an output interface 1600, and the like.

In addition, the components included in the computing system 1000 may each be connected to a bus 1700 to communicate with each other.

An example of the computing system 1000 of the present disclosure may include a communicable desktop computer, laptop computer, notebook, smartphone, tablet PC, mobile phone, smart watch, smart glasses, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA), and/or the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An information acquisition and communication method for an unmanned aerial vehicle (UAV), the method comprising:
acquiring, by at least one first device, at least one of operational information or traffic information of the at least one unmanned aerial vehicle;
providing, by the at least one first device, the at least one of the operational information or the traffic information of the at least one unmanned aerial vehicle to the at least one unmanned aerial vehicle or to a base station affecting the communication operation of the at least one unmanned aerial vehicle; and
determining, by the at least one unmanned aerial vehicle or the base station, the communication operation of the at least one unmanned aerial vehicle based on the at least one of the operational information or the traffic information of the at least one unmanned aerial vehicle.

2. The method of claim 1, wherein the acquiring of the at least one of the operational information or the traffic information of the at least one unmanned aerial vehicle comprises:
acquiring the at least one of the operational information or the traffic information of the at least one unmanned aerial vehicle within a sub-region; and
obtaining the at least one of the operational information or the traffic information by collecting the operational information or traffic information of the at least one unmanned aerial vehicle within a super-region of the sub-region.

3. The method of claim 1, wherein the acquiring of the at least one of the operational information or the traffic information of the at least one unmanned aerial vehicle comprises:
acquiring the operational information, including speed, altitude, or mobility of the at least one unmanned aerial vehicle; and
acquiring the traffic information, including congestion or cluster information of the at least one unmanned aerial vehicle within a predetermined region, based on the operational information of the at least one unmanned aerial vehicle.

4. The method of claim 1, wherein the determining of the communication operation of the at least one unmanned aerial vehicle based on the at least one of the operational information or the traffic information comprises determining communication link adaptation between the base station and the at least one unmanned aerial vehicle based on the at least one of the operational information or the traffic information.

5. The method of claim 4, wherein the determining of communication link adaptation between the base station and the at least one unmanned aerial vehicle based on the at least one of the operational information or the traffic information comprises, determining communication link adaptation between the base station and the at least one unmanned aerial vehicle based on the operational information of the at least one unmanned aerial vehicle and channel status information between the base station and the at least one unmanned aerial vehicle, when the operational information of the at least one unmanned aerial vehicle is obtained.

6. The method of claim 4, wherein the determining of communication link adaptation between the base station and the at least one unmanned aerial vehicle based on the at least one of the operational information or the traffic information comprises, determining communication link adaptation between the base station and the at least one unmanned aerial vehicle based on the operational information, the traffic information, and channel status information between the base station and the at least one unmanned aerial vehicle, when the traffic information and operational information of the at least one unmanned aerial vehicle within a region to which the at least one unmanned aerial vehicle belongs is obtained.

7. The method of claim 4, wherein the determining of communication link adaptation between the base station and the at least one unmanned aerial vehicle based on the at least one of the operational information or the traffic information comprises, when the traffic information or the operational information of the at least one unmanned aerial vehicle within a region to which the at least one unmanned aerial vehicle belongs is unavailable, determining communication link adaptation between the base station and the at least one unmanned aerial vehicle based on channel status information between the base station and the at least one unmanned aerial vehicle.

8. The method of claim 1, wherein the determining of the communication operation of the at least one unmanned aerial vehicle based on the at least one of the operational information or the traffic information comprises determining whether to perform cooperative communication between the base station and a second base station to support the communication of the at least one unmanned aerial vehicle based on the at least one of the operational information or the traffic information.

9. The method of claim 8, wherein the determining of whether to perform cooperative communication between the base station and the second base station comprises:
predicting the communication performance based on available resources within a region to which the at least one unmanned aerial vehicle belongs;
evaluating whether the predicted communication performance meets a required communication performance for the at least one unmanned aerial vehicle; and
determining whether to perform cooperative communication between the base station and the second base station based on the evaluation result.

10. The method of claim 9, wherein the determining of whether to perform cooperative communication between the base station and the second base station further comprises determining a region to be provided with communication support and regions available for communication support using the cooperative communication.

11. A communication system for acquiring and utilizing information for at least one unmanned aerial vehicle (UAV), the communication system comprising:
at least one unmanned aerial vehicle;
a base station affecting the communication operation of the at least one unmanned aerial vehicle; and
at least one first device for acquiring at least one of operational information or traffic information of the at least one unmanned aerial vehicle,
wherein the at least one first device is configured to provide the at least one of the operational information or the traffic information of the at least one unmanned aerial vehicle to the at least one unmanned aerial vehicle or the base station, and
wherein the at least one unmanned aerial vehicle or the base station is configured to determine the communication operation of the at least one unmanned aerial vehicle based on the at least one of the operational information or the traffic information of the at least one unmanned aerial vehicle.

12. The communication system of claim 11, wherein the at least one first device is further configured to:
acquire the at least one of the operational information or the traffic information of the at least one unmanned aerial vehicle within a sub-region, and
obtain the at least one of the operational information or the traffic information by collecting the operational information or traffic information of the at least one unmanned aerial vehicle within a super-region of the sub-region.

13. The communication system of claim 11, wherein the at least one first device is further configured to:
acquire the operational information including speed, altitude, or mobility of the at least one unmanned aerial vehicle, and based on the operational information of the at least one unmanned aerial vehicle, and
acquire the traffic information including congestion or cluster information of the at least one unmanned aerial vehicle within a predetermined region.

14. The communication system of claim 11, wherein the at least one unmanned aerial vehicle or the base station is further configured to determine communication link adaptation between the base station and the at least one unmanned aerial vehicle based on the at least one of the operational information or the traffic information.

15. The communication system of claim 14, wherein the at least one unmanned aerial vehicle or the base station is further configured to determine communication link adaptation between the base station and the at least one unmanned aerial vehicle based on the operational information of the at least one unmanned aerial vehicle and channel status information between the base station and the at least one unmanned aerial vehicle, when the operational information of the at least one unmanned aerial vehicle is obtained.

16. The communication system of claim 14, wherein the at least one unmanned aerial vehicle or the base station is further configured to determine communication link adaptation between the base station and the at least one unmanned aerial vehicle based on the operational information, traffic information, and channel status information between the base station and the at least one unmanned aerial vehicle, when the traffic information and operational information of the at least one unmanned aerial vehicle within a region to which the at least one unmanned aerial vehicle belongs is obtained.

17. The communication system of claim 14, wherein the at least one unmanned aerial vehicle or the base station is further configured to determine communication link adaptation between the base station and the at least one unmanned aerial vehicle based on the channel status information between the base station and the at least one unmanned aerial vehicle, when the traffic information or operational information of the at least one unmanned aerial vehicle within the region to which the at least one unmanned aerial vehicle belongs is unavailable.

18. The communication system of claim 14, further comprising a second base station, wherein the at least one unmanned aerial vehicle, the base station, or the second base station is further configured to determine whether to perform cooperative communication between the base station and the second base station to support communication of the at least one unmanned aerial vehicle based on the at least one of the operational information or the traffic information.

19. The communication system of claim 18, wherein the at least one unmanned aerial vehicle, the base station, or the second base station is further configured to:
predict communication performance based on available resources within a region to which the at least one unmanned aerial vehicle belongs,
evaluate whether the predicted communication performance meets a required communication performance for the at least one unmanned aerial vehicle, and
determine whether to perform cooperative communication between the base station and the second base station based on the evaluation result.

20. The communication system of claim 19, wherein the at least one unmanned aerial vehicle, the base station, or the second base station is further configured to determine a region to be provided with communication support and regions available for communication support using the cooperative communication.
